(19) United States
(12) Patent Application Publication
(10) Pub. No.: US 2025/0286177 A1
(43) Pub. Date: Sep. 11, 2025

(54) SECONDARY BATTERY TOP COVER AND SECONDARY BATTERY

(71) Applicant: Trina Storage Solutions (Jiangsu) Co., Ltd, Changzhou (CN)

(72) Inventors: Lin Lu, Changzhou (CN); Shunli Li, Changzhou (CN); Zhiyi Jiang, Changzhou (CN)

(21) Appl. No.: 18/861,166

(22) PCT Filed: Apr. 28, 2023
(86) PCT No.: PCT/CN2023/091741

§ 371 Date: Oct. 28, 2024

(30) Foreign Application Priority Data
Apr. 29, 2022 (CN) 202221040509.5

(51) Int. Cl. H01M 50/15; H01M 50/103; H01M 50/143; H01M 50/176; H01M 50/186; H01M 50/516; H01M 50/557; H01M 50/627

(52) U.S. Cl. CPC H01M 50/15; H01M 50/103; H01M 50/143; H01M 50/176; H01M 50/186; H01M 50/516; H01M 50/557; H01M 50/627

(57) ABSTRACT

The present disclosure relates to a secondary battery top cover and a secondary battery. The secondary battery top cover comprises a top cover piece, a post and a connecting assembly, wherein the top cover piece is provided with a through hole; the post is mounted in the through hole; and the connecting assembly is arranged between the top cover piece and the post, and is used for fixing the post onto the top cover piece. The post has at least one through hole and an electrode contact region, the at least one through hole being configured to allow a tab inside a battery to pass therethrough, and the electrode contact region being configured to be in electrical contact with the tab that passes through the at least one through hole. In the secondary battery top cover of the present disclosure, at least one through hole is provided in the post, such that a tab is welded to the post outside a case, which eliminates an internal short circuit of a battery that is caused by welding slag or welding filings, etc. generated by internal welding of the battery, and also eliminates associated thermal runway.

### TECHNICAL FIELD

The present disclosure relates to the field of batteries, and in particular to a secondary battery top cover and a secondary battery.

### BACKGROUND

Secondary batteries can provide sufficient power for electrical equipment. Secondary batteries, such as lithium-ion batteries, have played a role in new energy vehicles and other products. The secondary battery generally adopts a prismatic hard shell structure, and the secondary battery shell includes a shell and a top cover assembly. The secondary battery shell provides a closed space to accommodate the electrode assembly and the electrolyte, and the tab of the electrode assembly is connected with the post of the top cover assembly, so that the electric energy of the electrode assembly is drawn out from the confined space to the outside of the confined space. The connection between the post of the existing top cover assembly and the tab of the electrode assembly is converted and connected by a butterfly-shaped adapter, and one end of the adapter is ultrasonically welded with the tab, and the other end is laser welded with the post. Both connections are carried out inside the secondary battery, and laser welding slag, ultrasonic welding chips, and cathode and anode overlap caused by tab inversion are inevitable in the process, which may lead to short circuits in the internal circuit. In addition, the contact resistance of the two connections through ultrasonic welding and laser welding is large, and the heat generation is high under high current, which will bring great safety hazards to users.

### SUMMARY

The technical problem to be solved by the present disclosure is to provide a secondary battery top cover with simple structure and high safety and a secondary battery comprising the secondary battery top cover.

In order to solve the above technical problems, the present disclosure provides a secondary battery top cover, comprising: a top cover piece, a post and a connecting assembly, wherein the top cover piece is provided with a through hole; the post is mounted in the through hole; and the connecting assembly is arranged between the top cover piece and the post, and is used for fixing the post onto the top cover piece, the post has at least one through hole and an electrode contact region, the at least one through hole being configured to allow a tab inside a battery to pass therethrough, and the electrode contact region being configured to be in electrical contact with the tab that passes through the at least one through hole.

In one embodiment of the present disclosure, the tab is in electrical contact with the electrode contact region through laser welding.

In one embodiment of the present disclosure, the electrode contact region has at least one groove for accommodating the tab.

In one embodiment of the present disclosure, comprising a first post and a second post, and the sum of the areas of the first post and the second post occupies 50%˜90% of the area of the top cover piece.

In one embodiment of the present disclosure, further comprising a first sealing piece and a second sealing piece, wherein the first sealing piece is covered on the first post and seals the through hole, and the first sealing piece is electrically connected with the first post, the second sealing piece is covered on the second post and seals the through hole, and the second sealing piece is electrically connected with the second post.

In one embodiment of the present disclosure, the material of the first sealing piece is the same as the material of the first post, and the material of the second sealing piece is a composite material comprising the material of the second post.

In one embodiment of the present disclosure, the shape of the first post and the second post are the same or different.

In one embodiment of the present disclosure, the connecting assembly fixes the post on the top cover piece in a manner that comprises injection molding, riveting, welding and any one of the composite methods.

In one embodiment of the present disclosure, further comprising an explosion-proof valve assembly, the top cover piece is provided with an explosion-proof hole, and the explosion-proof valve assembly is installed on the explosion-proof hole.

In one embodiment of the present disclosure, further comprising a liquid injection hole positioned on the top cover piece.

Another aspect of the present disclosure also provides a secondary battery, comprising: a shell, an electrode assembly and a secondary battery top cover as described above, the shell has an opening, the electrode assembly comprises tabs, and the electrode assembly is accommodated in the shell; The secondary battery top cover covers the opening to enclose the electrode assembly in the shell.

The secondary battery top cover in the present disclosure is provided with at least one through hole on the post, so that the tab directly passes through the through hole from the bottom of the top cover piece without bending, and then the tab is electrically connected with the electrode contact region on the post outside the shell. The structure of the secondary battery top cover makes the top cover connection design and assembly process completely carried out outside the shell, which eliminates the internal short circuit and related thermal runaway caused by laser welding slag and ultrasonic welding chips. On the other hand, the tabs are directly connected to the posts, and the heat generation inside the cell is directly exported to the outside of the shell through the tabs, and the rapid heat dissipation through the large area of the posts realizes the rapid heat dissipation and temperature uniformity inside the cells, and improves the cycling performance of the cells.

### BRIEF DESCRIPTION OF THE DRAWINGS

The drawings are included to provide a further understanding of the present disclosure, and they are included and constitute a part of the present disclosure, the drawings show the embodiments of the present disclosure, and serving to explain the principles of the present disclosure together with the description. In the drawings:

FIG. 1 is a schematic diagram of the explosion of the secondary battery top cover of the embodiment of the present disclosure;

FIG. 2 is a vertical view of the secondary battery top cover in FIG. 1;

FIG. 3 is a schematic diagram of the structure of the post of the secondary battery top cover in FIG. 1;

FIG. 4 is a schematic diagram of the structure of the top cover piece of the secondary battery top cover in FIG. 1;

FIG. 5-FIG. 11 are the vertical view of the secondary battery top cover of the other embodiments of the present disclosure;

FIG. 12 is a front view of the secondary battery top cover in FIG. 11;

FIG. 13 is a schematic diagram of the structure of the secondary battery of the embodiment of the present disclosure.

### PREFERRED EMBODIMENT OF THE PRESENT DISCLOSURE

In order to make the above objects, features and advantages of the present disclosure more obvious and understandable, the specific embodiments of the present disclosure are described in detail below with reference to the accompanying drawings.

Many specific details are set forth in the following description in order to facilitate a full understanding of the present disclosure, but the present disclosure may also be implemented in other ways other than those described herein, and therefore the present disclosure is not limited by the specific embodiments disclosed below.

The embodiments shown below are examples of the secondary battery top cover and the secondary battery used to concretize the technical ideas of the present disclosure, and the secondary battery top cover and the secondary battery of the present disclosure are not specified as follows. Furthermore, in order to make it easier to understand the scope of the claims, the number corresponding to the component shown in the embodiment is assigned to the component shown in the “Claims” and “Summary” columns. However, the component shown in the claims is by no means specific to the component of the embodiment. In particular, if there is no specific description of the size, material, shape, and relative configuration of the constituent components recorded in the embodiment, the intention is not to limit the scope of the present disclosure to this, but only to illustrate the example.

As indicated in this application and claims, the terms “a”, “an”, “a kind of” and/or “the” do not specifically refer to the singular and may include the plural unless the context clearly indicates an exception. Generally speaking, the terms “comprising” and “including” only suggest the inclusion of clearly identified steps and elements, and these steps and elements do not constitute an exclusive list, and the method or device may also contain other steps or elements.

In the description of the present disclosure, it should be understood that orientation words such as “front, back, up, down, left, right”, “landscape, portrait, vertical, horizontal” and “top, bottom” etc. indicating the orientation or positional relationship is generally based on the orientation or positional relationship shown in the drawings, only for the convenience of describing the application and simplifying the description, in the absence of a contrary statement, these orientation words do not indicate or imply that the device or element referred to must have a specific orientation or be constructed and operated in a specific orientation, and therefore cannot be construed as limiting the scope of protection of this application; the orientation words “inside and outside” refer to inside and outside relative to the outline of each part itself.

In addition, it should be noted that the use of words such as “first” and “second” to define components is only for the convenience of distinguishing corresponding components, unless otherwise stated, the above words have no special meanings, and therefore cannot be construed as limiting the protection scope of the present disclosure. In addition, although the terms used in this application are selected from well-known and commonly used terms, some terms mentioned in the specification of this application may be selected by the applicant according to his or her judgment, and their detailed meanings are listed in this article described in the relevant section of the description. Furthermore, it is required that this application be understood not only by the actual terms used, but also by the meaning implied by each term.

However, the dimensions and position relationships of the components shown in the drawings are sometimes exaggerated for the sake of clarity. Furthermore, in the following description, it is appropriate to omit the detailed description of the same name and symbol indicating the same or homogeneous component. Furthermore, the elements constituting the present disclosure may be in the form of multiple elements constituting multiple elements from the same component, so that a single component can be used at the same time, or conversely, it may also be realized by multiple components sharing the functions of a component. In addition, the contents described in some embodiments and embodiments can also be used in other embodiments, embodiments, etc. In addition, in this manual, the word “up” is not limited to the case formed by contact with the upper surface, but also includes the case where the ground is formed separately from above, and also includes the existence of intermediate layers between layers.

At present, the secondary battery shell usually comprises a shell and a top cover, the secondary battery shell provides a closed space to accommodate the electrode assembly and the electrolyte, and the tabs of the electrode assembly are connected with the posts of the top cover, so that the electrical energy of the electrode assembly is drawn out from the closed space to the outside of the closed space. The connection between the existing post of the top cover and the tab is a conversion connection through an adapter piece, and one end of the adapter is ultrasonic welded with the tab and the other end is laser welded with the post. Both connections are performed inside the shell. Laser welding slag and ultrasonic welding chips are inevitably generated during welding, which may cause the internal circuit of the battery to be broken. Moreover, the contact resistance of the two connections through ultrasonic welding and laser welding is large, and the heat generation is high under large current, which brings great safety risks in large-current use scenarios.

The disclosure provides a secondary battery top cover and a secondary battery, by arranging at least one through hole on the post, allowing the tab to pass through the through hole directly from the bottom of the top cover piece without bending, and then electrically connecting the tab with the electrode contact region on the post outside the shell. The structure of the secondary battery top cover makes the top cover connection design and assembly process completely carried out outside the shell, which eliminates the internal short circuit and related thermal runaway caused by laser welding slag and ultrasonic welding chips. On the other hand, the tabs are directly connected to the posts, reducing the number of connections and greatly reducing the contact resistance, and the heat generation inside the cell is directly exported to the outside of the shell through the tabs, and the rapid heat dissipation through the large area of the posts realizes the rapid heat dissipation and temperature uniformity inside the cells, and improves the cycling performance of the cells.

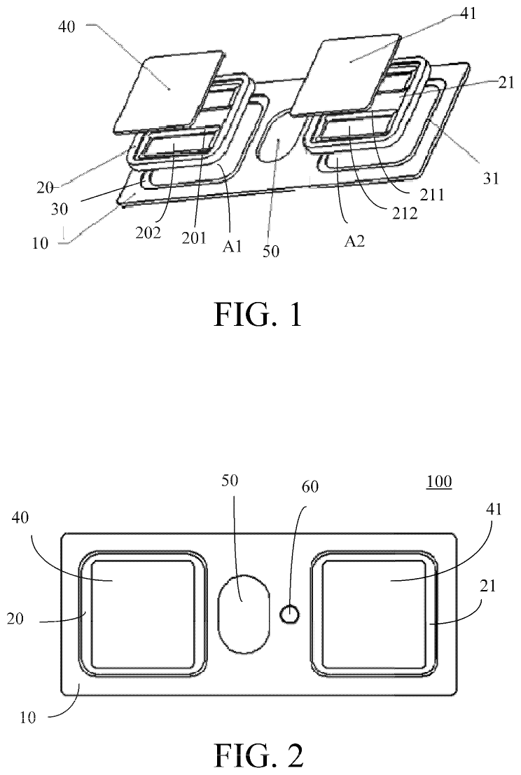

In order to better illustrate the secondary battery top cover of the present disclosure, it is described in detail below in conjunction with FIG. 1-10.

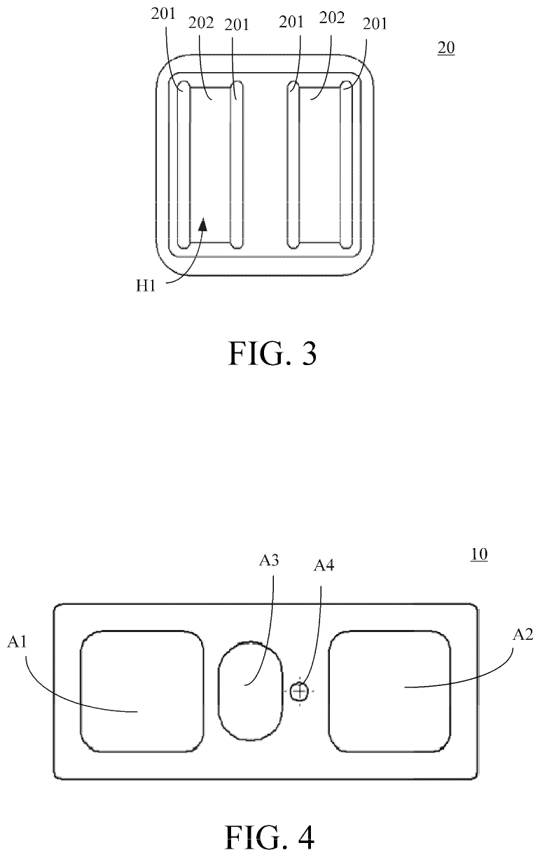

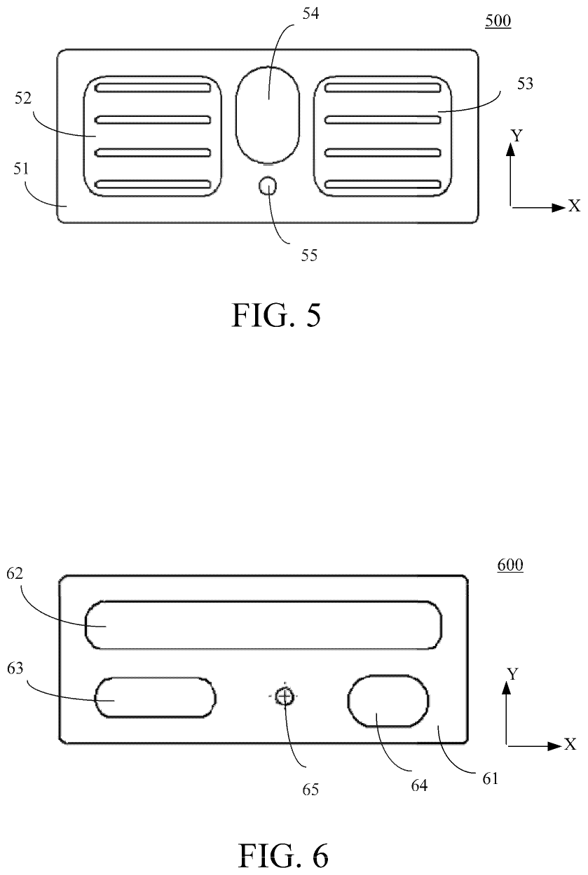

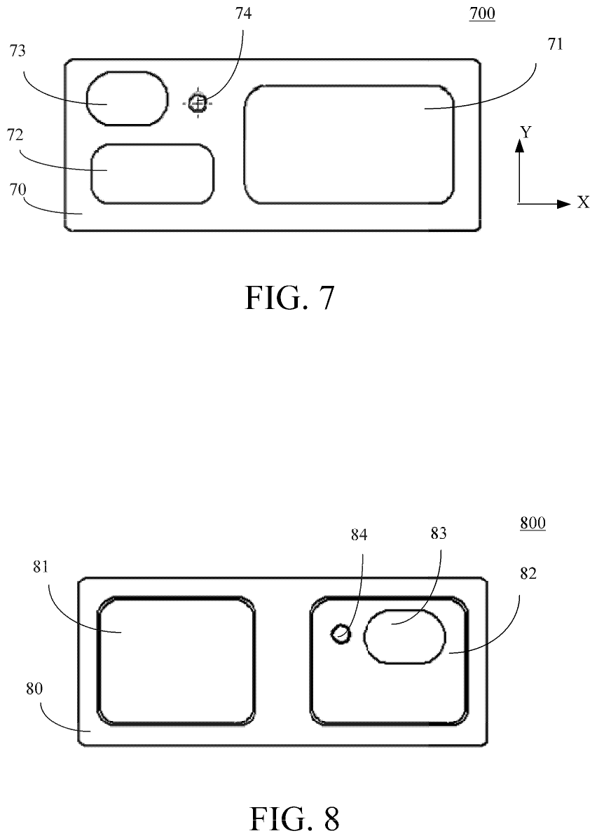

FIG. 1 is an exploded view of the secondary battery top cover of the embodiment of the present disclosure, FIG. 2 is a vertical view of the secondary battery top cover in FIG. 1, FIG. 3 is a schematic diagram of the structure of the post of the secondary battery top cover in FIG. 1, FIG. 4 is a schematic diagram of the structure of the top cover piece of the secondary battery top cover in FIG. 1. As shown in FIG. 1-FIG. 4, the secondary battery top cover 100 comprises a top cover piece 10, a post 20 and a connecting assembly 30. The top cover piece 10 is provided with a through hole A1, and the post 20 is mounted in the through hole A1. The connecting assembly 30 is arranged between the top cover piece 10 and the post 20 and used for fixing the post 20 on the top cover piece 10, wherein the post 20 has at least one through hole 201 and an electrode contact region 202. The at least one through hole 201 is configured to allow the tab (not shown in FIG. 1) inside the battery to pass through, and the electrode contact region 202 is configured to make electrical contact with the end of the tab passing through the at least one through hole. As shown in FIG. 3, the post 20 comprises four through holes 201, and the electrode contact region 202 is located between adjacent through holes. Continuing referring to FIG. 1, the tabs inside the battery pass through the through hole A1 and the through hole 201 to the upper surface of the post 20 in turn, the tabs are bent and attached to the electrode contact region 202, and the tabs are in electrical contact with the electrode contact region 202.

In some embodiments, the tab is electrically contacted with the electrode contact region 202 by laser welding.

In some embodiments, a secondary battery top cover comprises a first post and a second post. As shown in FIG. 1, the secondary battery top cover 100 further comprises a post 21, the post 20 can be used as the first post, and the post 21 can be used as the second post or vice versa. The present embodiment is only for schematic illustration, and the position of the second post is not limited. The top cover piece 10 is provided with a through hole A2, and the post 21 is mounted in the through hole A2. The connecting assembly 31 is arranged between the top cover piece 10 and the post 21, and the connecting assembly 31 is used for fixing the post 21 on the top cover piece 10, wherein the post 21 has at least one through hole 211 and an electrode contact region 212. The at least one through hole 211 is configured to allow the tab inside the battery to pass through, and the electrode contact region 212 is configured to make electrical contact with the end of the tab passing through the at least one through hole.

As shown in FIG. 1, the secondary battery top cover 100 further comprises a first sealing piece 40 and a second sealing sheet 41. Taking the post 20 as the first post and the post 21 as the second post as an example, the first sealing piece 40 is covered on the post 20, and the first sealing piece 40 is electrically connected with the post 20. The material of the post 20 is aluminum or aluminum alloy, and the material of the first sealing piece 40 is the same as that of the post 20, and the first sealing piece 40 can be welded to the post 20 by laser welding to seal the through hole 201. As shown in FIG. 3, because bending the tab and attaching it to the electrode contact region 202 will cause a certain protrusion, the electrode contact region 202 is configured as at least one groove H1, and the groove H1 is used to accommodate the tab attached to the electrode contact region 202. When the first sealing piece 40 is welded on the post 20 by laser welding, because a groove H1 is arranged on the electrode contact region 202, the first sealing piece 40 can be smoothly welded on the electrode contact region 202 of the post 20, and the tightness between the first sealing piece 40 and the post 20 is improved. In some embodiments, a groove is provided on the surface of the first sealing piece 40 attached to the post 20, which is used to accommodate the tab protruding on the electrode contact region 202, and also ensures the flatness of the welding between the first sealing piece 40 and the post 20, thereby improving the sealing performance between the first sealing piece 40 and the post 20. The second sealing piece 41 covers the post 21, and the second seal piece 41 is electrically connected with the post 21. The material of the post 21 is copper or iron alloy, and the material of the second sealing piece 41 is a composite material comprising the material of the post 21. For example, the material of the post 21 is copper, the material of the second sealing piece 41 is a copper-aluminum composite material, specifically, the surrounding edge of the second sealing piece 41 is a copper material, and the central area of the second sealing piece 41 is an aluminum or aluminum alloy material. The material of the post 21 is identical to the material of the surrounding edges of the second sealing piece 41 such that the second sealing piece 41 can be laser welded with the post 21 to seal the through hole 211. The central area of the second sealing piece 41 can be laser welded with the positive post of other secondary batteries to realize series or parallel connection between cells.

As shown in FIG. 1-4, the secondary battery is loaded with a large number of chemicals, such as electrolytes, and a large amount of mixed gases and liquids are generated during the charging and discharging process, accompanied by the accumulation of pressure. Therefore, in order to prevent the explosion that occurs due to excessive pressure in the secondary battery, the secondary battery top cover 100 further comprises an explosion-proof valve assembly 50 (the explosion-proof valve assembly 50 in FIG. 1 is not disassembled). The top cover piece 10 is provided with an explosion-proof hole A3, and the explosion-proof valve assembly is arranged on the explosion-proof hole A3. In some embodiments, the explosion-proof valve assembly 50 comprises a protective patch and an explosion-proof piece, the explosion-proof piece is arranged on the explosion-proof hole A3 of the top cover piece 10, and the protective patch is pasted on the explosion-proof piece to realize the sealing of the explosion-proof valve assembly.

As shown in FIG. 1-4, the secondary battery top cover 100 further comprises a liquid injection hole 60 located on the top cover piece 10. The liquid injection hole 60 is communicated with the liquid injection through hole A4 on the top cover piece 10. The liquid injection hole 60 is configured to inject the electrolyte into the battery according to the required amount, and the injection hole 60 is sealed after the electrolyte injection is completed.

As shown in FIG. 1, the method of fixing the post 20 to the top cover piece 10 with the connecting assembly 30 comprises any one of injection molding, riveting, welding and composite method. According to the different connection methods, the connecting assembly 30 has different structures. When the connection method is injection molding, the connecting assembly 30 comprises upper plastic, lower plastic and sealing ring. The post 20 sequentially penetrates the lower plastic, the sealing ring and the through-hole A1 from the lower surface of the top cover piece 10, presses on the top cover piece 10, and then polyphenylene sulfide (PPS) is adopted to inject the upper plastic, and finally the post 20 is installed on the upper surface of the top cover piece 10. When the connection method is riveting or welding, the connecting assembly 30 comprises a sealing ring and a riveting block. The post 20 sequentially penetrates through the sealing ring, the through hole A1 and the riveting block from the lower surface of the top cover piece 10, presses on the top cover piece 10, riveted or welded with the riveting block. The post 20 is fixed on the upper surface of the top cover piece 10, and the post and the top cover piece are insulated by insulators.

In some embodiments, the shape of the post is any one of polygonal, circular, elliptical, runway-shaped or deformed shapes with rounded corners, and the present disclosure does not limit the shape of the post. As shown in FIG. 1, the post 20 and the post 21 are of the same shape, both of which are squares with rounded corners.

In some embodiments, the sum of the areas of the first post and the second post occupies 50%˜90% of the area of the top cover piece. Based on the structure of the secondary battery top cover in the present disclosure, the heat generated inside the cell is directly exported to the outside of the shell through the tabs, and then the heat is dissipated through the posts. The larger the area of the post, the more efficient the heat dissipation. As shown in FIG. 1, the sum of the areas of the post 20 and the post 21 accounts for more than 60% of the area of the top cover piece 10. The large area of the post is used for heat dissipation, which realizes the rapid heat dissipation and temperature uniformity inside the cell, and improves the cycling performance of the cell.

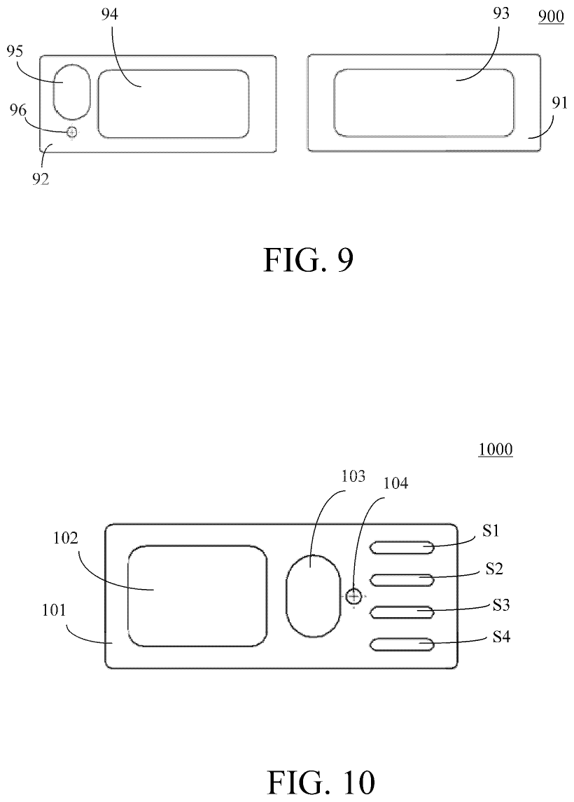

FIG. 5 is a vertical view of the secondary battery top cover 500 of the second embodiment of the present disclosure. As shown in FIG. 5, the secondary battery top cover 500 comprises a top cover piece 51, a post 52, a post 53, a connecting assembly (not shown in FIG. 5), an explosion-proof valve 54 and a liquid injection hole 55. The difference between the secondary battery top cover 500 and the secondary battery top cover 100 is that the secondary battery top cover 500 does not include a first sealing piece and a second sealing piece. At the same time, there is no groove on the electrode contact region of the post 52 and the post 53. Compared with the secondary battery top cover 100, the structure of the secondary battery top cover 500 is simpler and the production efficiency is higher. Secondly, the explosion-proof valve 54 and the liquid injection hole 55 of the secondary battery top cover 500 are arranged along the Y direction, so that the sum of the areas of the post 52 and the post 53 accounts for a larger proportion of the area of the top cover piece 51, and the heat dissipation efficiency is better.

FIG. 6 is a vertical view of the secondary battery top cover 600 of the third embodiment of the present disclosure. As shown in FIG. 6, the secondary battery top cover 600 comprises a top cover piece 61, a post assembly 62 composed of a first post and a first sealing piece, a post assembly 63 composed of a second post and a second sealing piece, a connecting assembly (not shown in FIG. 6), an explosion-proof valve 64 and a liquid injection hole 65. The shape of the first post of the post assembly 62 is long runway shape, and the shape of the second post of the post assembly 63 is short runway shape, and the shape of the first post is different from that of the second post. Since the material of the positive electrode of the battery is aluminum or aluminum alloy, and the material of the negative electrode of the battery is copper or ferroalloy, the cost of the positive electrode of the battery is lower than that of the negative electrode of the battery. Because the area of the post assembly 62 is larger than the area of the post assembly 63, the post assembly 62 can be used as the positive electrode of the secondary battery to reduce the cost of the secondary battery top cover 600. In addition, in the present embodiment, the area of the post assembly 62 occupies 50% of the area of the top cover piece 61, and the explosion-proof valve 64, the liquid injection hole 65 and the post assembly 63 are arranged at the same level along the X direction, so that the sum of the area of the post assembly 62 and the post assembly 63 can occupy more than 75% of the area of the top cover piece 61, and the heat dissipation efficiency is better.

FIG. 7 is a vertical view of the secondary battery top cover 700 of the fourth embodiment of the present disclosure. As shown in FIG. 7, the secondary battery top cover 700 comprises a top cover piece 70, a post assembly 71 composed of a first post and a first sealing piece, a post assembly 72 composed of a second post and a second sealing piece, a connecting assembly (not shown in FIG. 7), an explosion-proof valve 73 and a liquid injection hole 74. The structure of the secondary battery top cover 700 is similar to that of the secondary battery top cover 600, the difference is that the post assembly 71 and the post assembly 72 of the secondary battery top cover 700 are arranged on two opposite sides in the X direction of the top cover piece 70, and the shape of the first post of the post assembly 71 and the second post of the post assembly 72 are rectangular with rounded corners. Such a structure makes the sum of the areas of the post assembly 71 and the post assembly 72 greater than the sum of the areas of the post assembly 61 and the post assembly 62 of the secondary battery top cover 600, and the heat dissipation efficiency is better.

FIG. 8 is a vertical view of the secondary battery top cover 800 of the fifth embodiment of the present disclosure. As shown in FIG. 8, the secondary battery top cover 800 comprises a top cover piece 80, a post assembly 81 composed of a first post and a first sealing piece, a post assembly 82 composed of a second post and a second sealing piece, a connecting assembly (not shown in FIG. 8), an explosion-proof valve 83 and a liquid injection hole 84. The second sealing piece of the post assembly 82 has a through hole, and the shape of the through hole is the same as that of the explosion-proof valve 83 and the liquid injection hole 84. The explosion-proof valve 83 and the liquid injection hole 84 pass through this through hole and are exposed on the surface of the second sealing piece. Such a structure makes the post assembly 81 and the post assembly 82 have more area to conduct electricity and dissipate heat, and the heat dissipation efficiency is better.

FIG. 9 is a vertical view of the secondary battery top cover 900 of the sixth embodiment of the present disclosure. As shown in FIG. 9, the secondary battery top cover 900 comprises a top cover piece 91, a top cover piece 92, a post assembly 93 composed of a first post and a first sealing piece, a post assembly 94 composed of a second post and a second sealing piece, a connecting assembly (not shown in FIG. 9), an explosion-proof valve 95 and a liquid injection hole 96. When the tabs of the cell are not drawn out in the same plane, but are drawn out from opposite sides respectively. Correspondingly, the first post of the post assembly 93 is mounted on the top cover piece 91 by means of the connecting assembly. The second post of the post assembly 94 is arranged on the top cover piece 92 through the connecting assembly, and the explosion-proof valve 95 and the liquid injection hole 96 are installed on the top cover piece 92.

FIG. 10 is a vertical view of the secondary battery top cover 1000 in the seventh embodiment of the present disclosure. As shown in FIG. 10, the secondary battery top cover 1000 comprises a top cover piece 101, a post assembly 102 composed of a second post and a second sealing piece, a connecting assembly (not shown), an explosion-proof valve 103 and a liquid injection hole 104. The top cover piece 101 is set as the first post of the secondary battery top cover 1000. The top cover piece 101 has at least four through holes, and the four through holes are S1, S2, S3, and S4 respectively which are configured to allow the tabs inside the battery to pass through. The top cover piece 101 also has mounting holes (not shown) for separately installing the post assembly 102, explosion-proof valve 103, and liquid injection hole 104. The remaining area of the top cover piece 101, except for the through-hole, is the electrode contact region. Such a structure makes the first post and the second post have more area to conduct electricity and dissipate heat, and the heat dissipation efficiency is better.

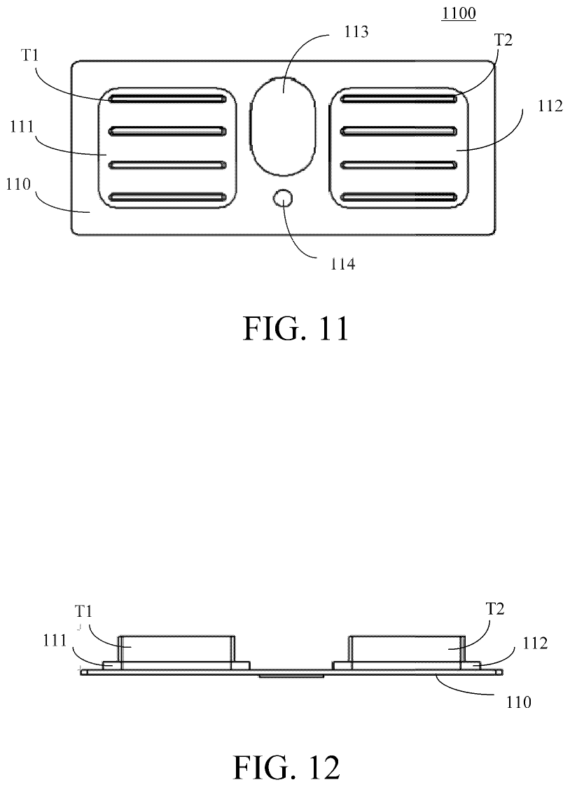

FIG. 11 is a vertical view of the secondary battery top cover 1100 of the eighth embodiment of the present disclosure. FIG. 12 is a front view of the secondary battery top cover 1100 of FIG. 11. As shown in FIG. 11 and FIGS. 12, the secondary battery top cover 1000 comprises a top cover piece 110, a post 111, a post 112, a connecting assembly (not shown in FIG. 11), an explosion-proof valve 113 and a liquid injection hole 114. The post 111 has an integrally formed protrusion T1, the protrusion T1 is located above the through hole, and the protrusion T1 is a hollow structure sealed at the top, just like a hat. After the tab passes through the through hole of the post 111, the tab is vertically connected with the protrusion T1. The tabs no longer need to be bent, and the resistance value of the tabs is reduced, which can effectively reduce the heating of the tabs. Similarly, the post 112 has an integrally formed protrusion T2, the protrusion T2 is located above the through hole, the protrusion T2 is a hollow structure sealed at the top, and after the tab passes through the through hole of the post 112, the tab is vertically electrically connected with the protrusion T2.

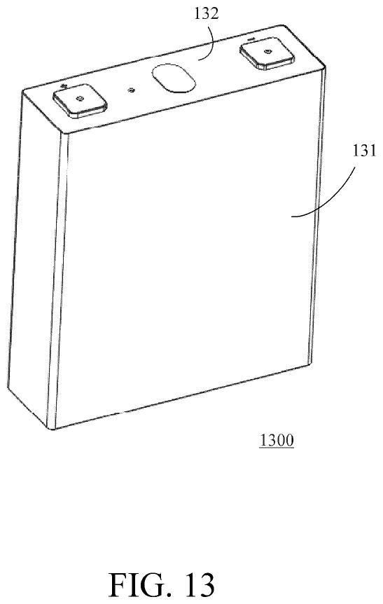

FIG. 13 is a schematic diagram of the structure of the secondary battery of the first embodiment of the present disclosure. As shown in FIG. 13, the secondary battery 1300 comprises a shell 131, an electrode assembly (not shown in FIG. 13) and a secondary battery top cover 132 as described above. The upper part of the shell 131 has an opening, which is covered by the secondary battery top cover 132 to enclose the electrode assembly in the shell 131.

The application provides a secondary battery top cover and a secondary battery, by arranging at least one through hole on the post, allowing the tab to pass directly through the through hole from the inside of the battery without bending, and then electrically connecting the tab with the electrode contact region on the post outside the shell. The structure of the secondary battery top cover makes the top cover connection design and assembly process completely carried out outside the shell, which eliminates the internal short circuit and related thermal runaway caused by laser welding slag and ultrasonic welding chips. On the other hand, the tabs are directly connected to the posts, and the heat generation inside the cell is directly exported to the outside of the shell through the tabs, and the rapid heat dissipation through the large area of the posts realizes the rapid heat dissipation and temperature uniformity inside the cells, and improves the cycling performance of the cells.

some of the embodiments of the application that are currently considered useful are discussed in the above disclosure through various examples, it should be understood that such details serve the purpose of illustration only, and the additional claims are not limited to the embodiments disclosed, but on the contrary, the claims are intended to cover all amendments and equivalent combinations that conform to the substance and scope of the embodiments of the present disclosure.

In the same way, it should be noted that in order to simplify the expression disclosed in the present disclosure and help the understanding of one or more embodiments of the disclosure, in the foregoing description of the embodiments of the present disclosure, sometimes multiple features are combined into one embodiment, drawings or descriptions thereof. However, this method of disclosure does not imply that the subject matter of the application requires more features than are recited in the claims. Indeed, embodiment features are less than all features of a single foregoing disclosed embodiment.

In some embodiments, numbers describing the quantity of components and attributes are used, it should be understood that such numbers used in the description of the embodiments use the modifiers “about”, “approximately” or “substantially” in some examples. Unless otherwise stated, “about”, “approximately” or “substantially” indicates that the stated figure allows for a variation of +20%. Accordingly, in some embodiments, the numerical parameters used in the specification and claims are approximations that can vary depending upon the desired characteristics of individual embodiments. In some embodiments, numerical parameters should take into account the specified significant digits and adopt the general digit reservation method. Although the numerical ranges and parameters used in some embodiments of the present disclosure to confirm the breadth of the scope are approximate values, in specific embodiments, such numerical values are set as precisely as practicable.

Although the present disclosure has been described with reference to the current specific embodiments, those of ordinary skill in the art should recognize that the above embodiments are only used to illustrate the present disclosure, and various equivalent changes or substitutions can also be made without departing from the spirit of the present disclosure, therefore, as long as the changes and modifications to the above-mentioned embodiments are within the spirit of the present disclosure, they will all fall within the scope of the claims of the present disclosure.

1. A secondary battery top cover, comprising: a top cover piece, a post and a connecting assembly, the top cover piece being provided with a through hole; the post being mounted in the through hole; and the connecting assembly being arranged between the top cover piece and the post, and used for fixing the post onto the top cover piece, wherein,
the post has at least one through hole and an electrode contact region, the at least one through hole being configured to allow a tab inside a battery to pass therethrough, and the electrode contact region being configured to be in electrical contact with the tab that passes through the at least one through hole.

2. The secondary battery top cover of claim 1, wherein, the tab is in electrical contact with the electrode contact region with laser welding.

3. The secondary battery top cover of claim 1, wherein, the electrode contact region has at least one groove for accommodating the tab.

4. The secondary battery top cover of claim 1, comprising a first post and a second post, and the sum of the areas of the first post and the second post occupies 50%˜90% of the area of the top cover piece.

5. The secondary battery top cover of claim 4, further comprising a first sealing piece and a second sealing piece, wherein the first sealing piece is covered on the first post and seals the through hole, and electrically connected with the first post, and the second sealing piece is covered on the second post and seals the through hole, and electrically connected with the second post.

6. The secondary battery top cover of claim 5, wherein, the material of the first sealing piece is the same as the material of the first post, and the material of the second sealing piece is a composite material comprising the material of the second post.

7. The secondary battery top cover of claim 4, wherein, the shape of the first post and the second post are the same or different.

8. The secondary battery top cover of claim 1, wherein, the connecting assembly fixes the post on the top cover piece in a method that comprises any one of injection molding, riveting, welding and composite method.

9. The secondary battery top cover of claim 1, further comprising an explosion-proof valve assembly, the top cover piece being provided with an explosion-proof hole, and the explosion-proof valve assembly being installed on the explosion-proof hole.

10. The secondary battery top cover of claim 1, further comprising a liquid injection hole positioned on the top cover piece.

11. A secondary battery, comprising:
a shell with an opening;
an electrode assembly comprising tabs and accommodated in the shell; and
a secondary battery top cover according to claim 1, which covers the opening so that the electrode assembly is enclosed in the shell.
